(19) United States
(12) Patent Application Publication
(10) Pub. No.: US 2014/0028466 A1
(43) Pub. Date: Jan. 30, 2014

(54) METHOD AND SERVER FOR MONITORING ENERGY SOURCE

(71) Applicant: HON HAI PRECISION INDUSTRY CO., LTD., New Taipei (TW)

(72) Inventor: TSUNG-CHE TSAI, New Taipei (TW)

(73) Assignee: HON HAI PRECISION INDUSTRY CO., LTD., New Taipei (TW)

(21) Appl. No.: 13/849,480

(22) Filed: Mar. 23, 2013

(30) Foreign Application Priority Data
Jul. 27, 2012 (TW) 101127190

(51) Int. Cl. G01D 4/00

(52) U.S. Cl. CPC G01D 4/002
USPC 340/870.02

(57) ABSTRACT

A method for monitoring energy source by a server receives a service request transmitted by a user terminal, requesting to gather statistics of an energy usage situation of a monitor object corresponding to an energy sensor. The server obtains energy input quantity and energy output quantity of the monitor object detected by the energy sensor according to the service request. The server gathers the statistics of the energy usage situation of the monitor object according to the energy input quantity and the energy output quantity. The server creates an energy monitor report according to the statistics of the energy usage situation of the monitor object, and transmits the energy monitor report to the user terminal

### BACKGROUND

1. Technical Field

Embodiments of the present disclosure relate to energy source monitor systems and methods, and particularly to a method and a server for monitoring an energy source.

2. Description of Related Art

Since global warming has become a serious environmental concern for humans, establishing a measure for saving energy and reducing carbon dioxide is becoming an important project of enterprises. The enterprises monitor an energy usage rate and greenhouse gases exhausted to realize the energy usage rate by monitoring production equipment and power supply systems. Whether the energy usage rate is accurate and effective decides the accuracy of the measure for saving energy and reducing the carbon footprint established by the enterprise.

Therefore, there is room for improvement within the prior art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present embodiments.

FIG. 1 is an operation environment diagram of one embodiment of a present disclosure.

FIG. 2 is a block diagram of one embodiment of a server including an energy monitor system for monitoring an energy source.

FIG. 3 is a schematic diagram illustrating an example of an energy monitor report.

FIG. 4 is a schematic diagram illustrating another example of an energy monitor report.

FIG. 5 is a schematic diagram illustrating another example of an energy monitor report.

FIG. 6 is a flowchart of one embodiment of a method for monitoring energy source.

### DETAILED DESCRIPTION

In general, the word “module,” as used herein, refers to logic embodied in hardware or firmware, or to a collection of software instructions, written in a programming language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, flash memory, and hard disk drives.

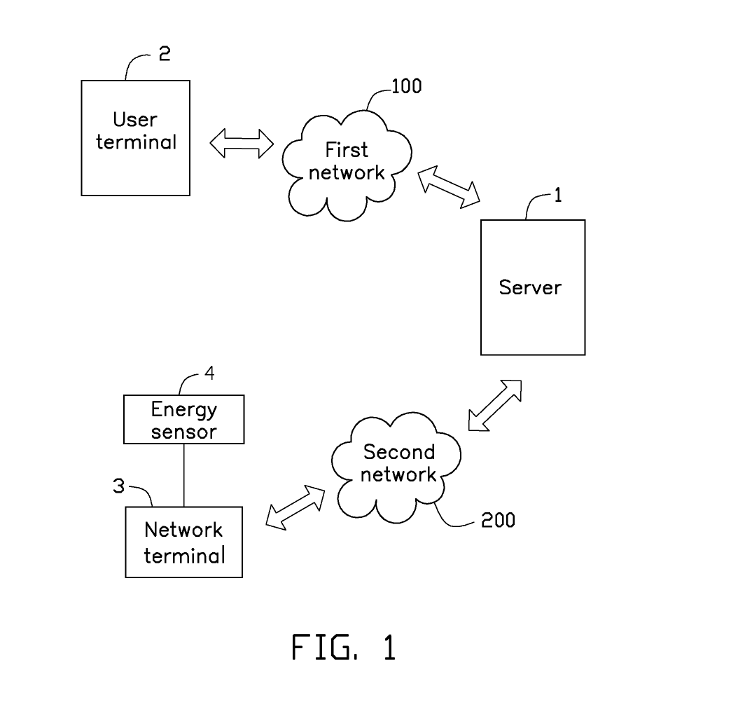

FIG. 1 is an operation environment diagram of one embodiment of a present disclosure. In the embodiment, a server 1 is electronically connected with a user terminal 2 via a first network 100. The server 1 may be a computing device, or a cloud server built by a plurality of servers in software-as-a-service (SAAS) mode. The user terminal 2 may be a personal computer, a mobile phone, or an electronic device, which has network communication functions.

The server 1 is electronically connected with a network terminal 3 via a second network 200. The network terminal 3 may be an industrial computer, a router, and an apparatus, which has network communication functions. The network terminal 3 is electronically connected with one or more energy sensors 4. Each energy sensor 4 detects an energy input quantity and an energy output quantity of a monitor object. The energy may be electricity or heat.

For example, if the monitor object is a power supply system of a factory, the energy sensor 4 is an intelligent electrical meter. The intelligent electrical meter can be located on a main electrical box of the factory. If the monitor object is a boiler, the energy sensor 4 corresponding to the boiler is a thermal sensor. The thermal sensors can be located at an inlet and an exit of the boiler to detect heat energy input quantity and heat energy output quantity of the boiler.

The network terminal 3 may obtain the energy input quantity and the energy output quantity from the energy sensor 4, and may transmit the energy input quantity and the energy output quantity to the server 1 via the second network 200.

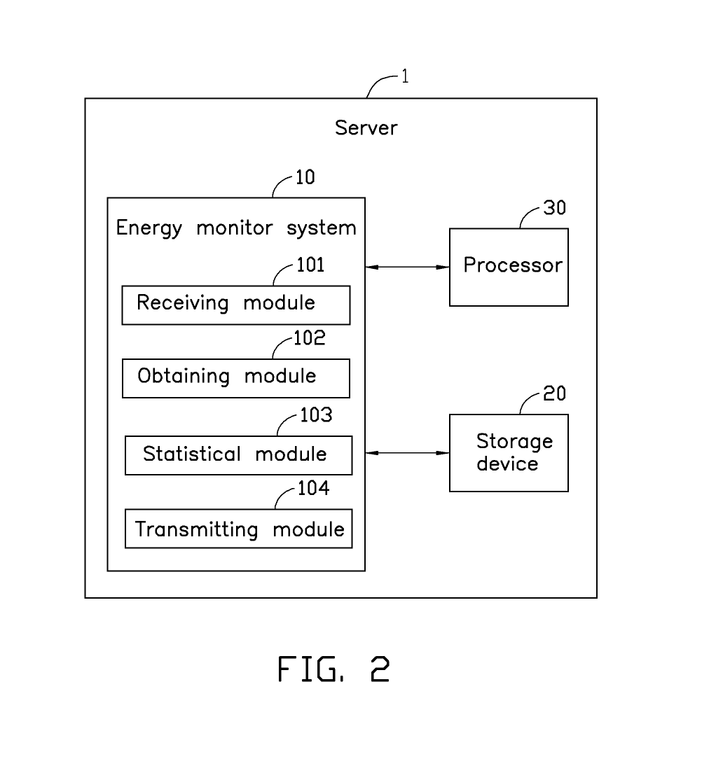

FIG. 2 is a block diagram of one embodiment of the server 1 including an energy monitor system 10 for monitoring an energy source. In the embodiment, the server 1 further includes a storage device 20 and at least one processor 30.

The storage device 20 saves a greenhouse gas conversion coefficient and a global warming potential (GWP) coefficient, which are published by a international union for conservation of nature (IUCN) or published by a national department for conservation of nature. The greenhouse gas conversion coefficient indicates that greenhouse gas equivalent exhausted in a procedure of energy loss per unit. For example, the greenhouse gas conversion coefficient of electricity provided by an electrical power company is zero point nine-nine-eight-seven kilogram of carbon dioxide per kilowatt to express that when the electricity consumes one kilowatt each time, the carbon dioxide of zero point nine-nine-eight-seven kilogram is exhausted.

The GWP coefficient is used for calculating carbon dioxide equivalent (CO2e) of the greenhouse gases. The CO2e of the greenhouse gas can be determined by multiplying the equivalent of the greenhouse gas by the GWP coefficient. For example, the GWP coefficient of the methane is twenty-seven to indicate that greenhouse effect resulted by the methane exhausting one kilogram is equal to greenhouse effect resulted by the carbon dioxide exhausting twenty-seven kilograms.

The storage device 20 saves a plurality of formulas for calculating an usage situation, such as a formula for calculating energy loss, a formula for calculating an energy usage rate, a formula for calculating the CO2e, a formula for calculating energy consumption of output value per unit, a formula for calculating energy consumption of throughput per unit, for example.

The energy monitor system 10 includes a receiving module 101, an obtaining module 102, a statistical module 103, and a transmitting module 104. The modules may comprise computerized instructions in the form of one or more programs that are stored in the storage device 20 and executed by the at least one processor 30. In one embodiment, the storage device 20 may be an internal storage system, such as a random access memory (RAM) for temporary storage of information, and/or a read only memory (ROM) for permanent storage of information. In some embodiments, the storage device 20 may also be an external storage system, such as an external hard disk, a storage card, or a data storage medium.

The receiving module 101 receives a service request requested by the user terminal 2. The service request is requested to gather statistics of the energy usage situation of the monitor object corresponding to the energy sensors 4. The energy usage situation of the monitor object includes the energy loss, the energy usage rate, the CO2e exhausted from the monitor object, and the like.

In the embodiment, a browser is installed in the user terminal 2. A user may do a keyword search using the browser. For example, when the user wants using the browser to search the energy consumption of a boiler, the user may input the keywords, such as “boiler” and “energy consumption”. The user terminal 2 generates the service request according to the keywords input by the user, and transmits the service request to the server 1.

The obtaining module 102 obtains energy input quantity and energy output quantity of the monitor object detected by the energy sensor 4 via the network terminal 3 according to the service request.

The statistical module 103 loads the greenhouse gas conversion coefficient, the GWP coefficient, and the formulas form the storage device 20. Gathering the statistics of the energy usage situation of the monitor object includes the energy loss, the energy usage rate, the CO2e exhausted from the monitor object, according to the energy input quantity and the energy output quantity.

For example, if the monitor object is a boiler, heat energy input quantity of the boiler may be thirty-five kilocalorie and the heat energy output quantity of the boiler may be thirty-three point five kilocalorie. The energy loss of the boiler is a difference between the heat energy input quantity and the heat energy output quantity, which is one point five kilocalorie. The energy usage rate of the boiler is a ratio value of the heat energy output quantity and the heat energy input quantity, which is: 33.5÷35×100%=95.7%. If the greenhouse gas conversion coefficient of heat is zero point eight-eight-seven kilogram per kilocalorie, the energy loss of one point five kilocalorie can exhaust the carbon dioxide of one point three-three kilogram. The GWP coefficient of the carbon dioxide is one identifying that the CO2e exhausted from the boiler is one point three-three kilogram.

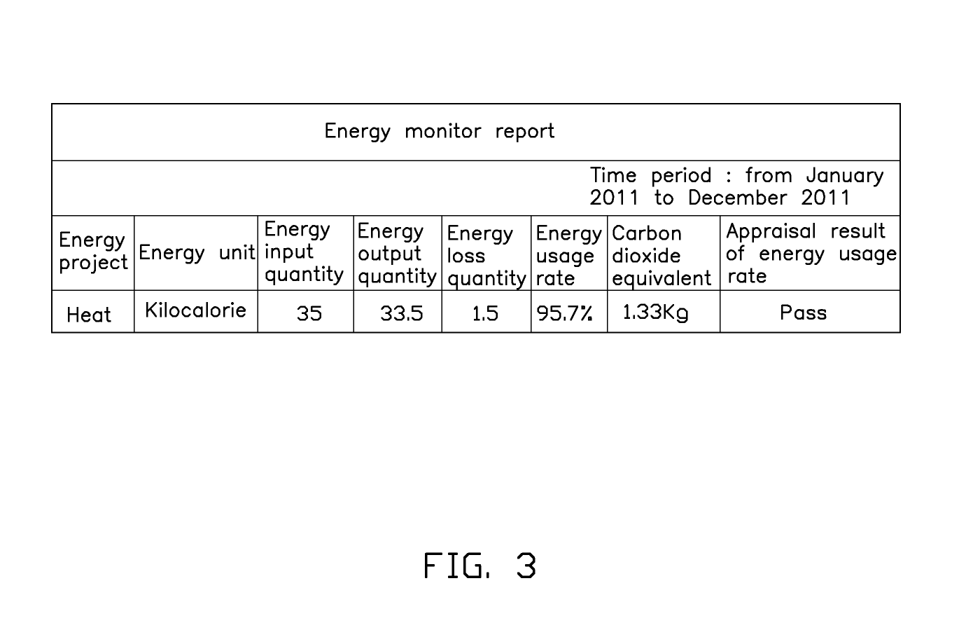

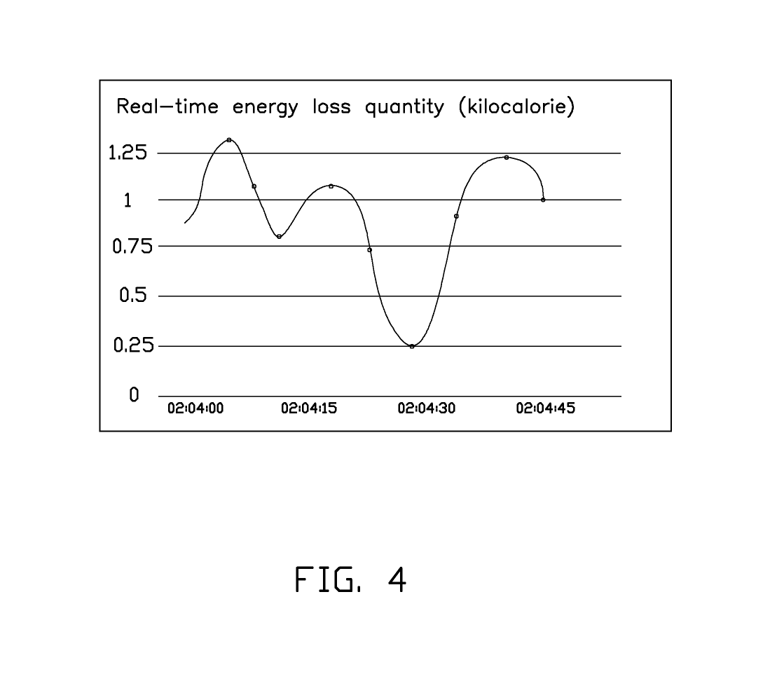

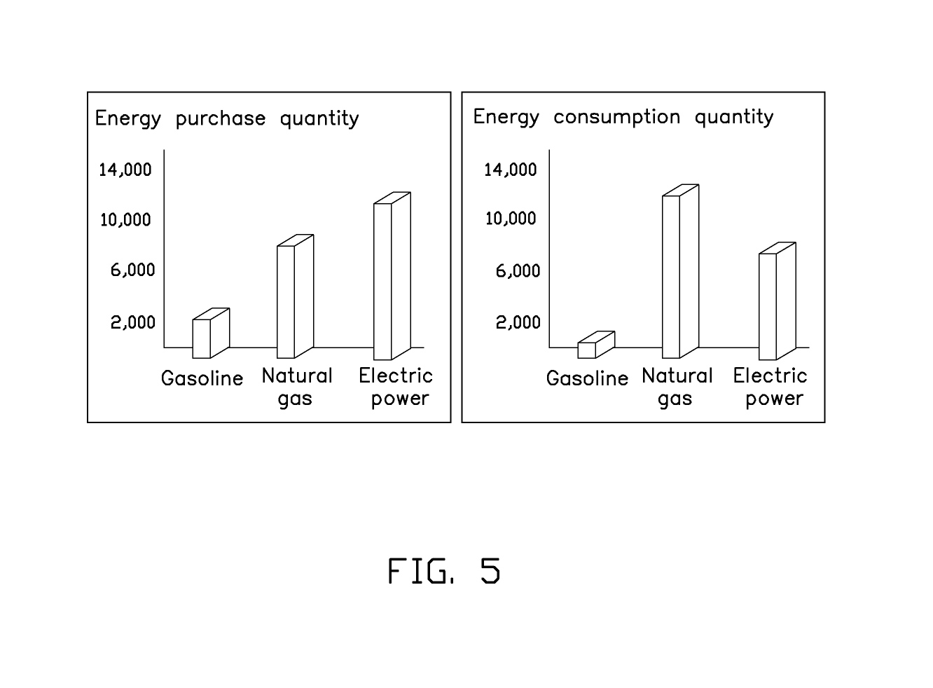

The transmitting module 104 creates an energy monitor report according to the statistics of the energy usage situation of the monitor object, and transmits the energy monitor report to the user terminal 2 for the user to check and to analyze. The energy monitor report may be formats of a diagram (shown in FIG. 3), a curve diagram (shown in FIG. 4), and a histogram (shown in FIG. 5).

The transmitting module 104 further saves the energy usage situation into the storage device 20 to provide the user with continuous monitoring. The receiving module 101 further receives energy purchase quantity, an energy inventory, energy unit price, and a period of a statistic. The period of the statistic may provide an advice for following energy using plains according to the energy usage situation of a yearly statistic, and a monthly statistic.

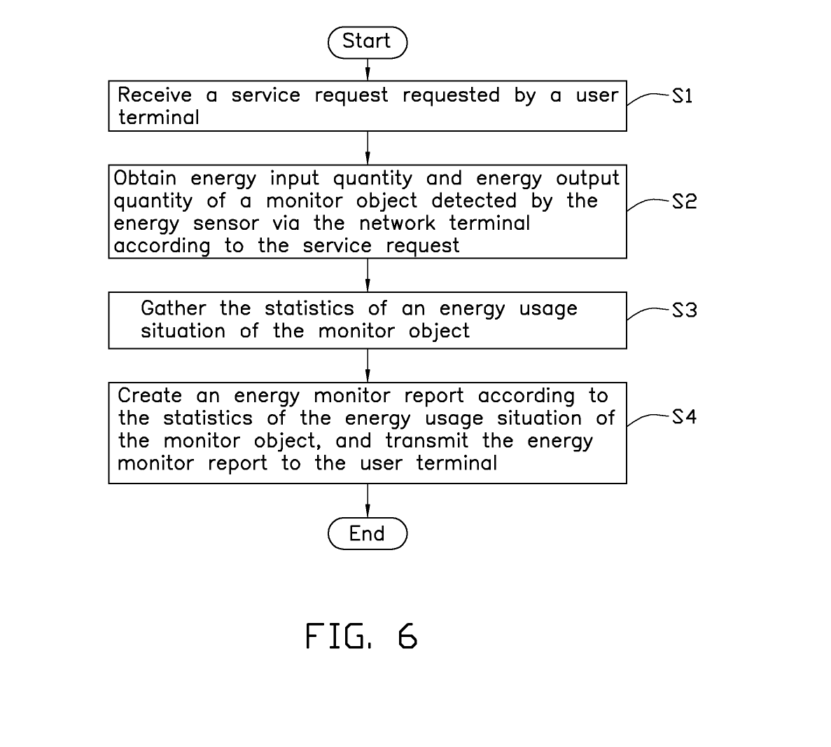

FIG. 6 is a flowchart of the embodiment of a method for monitoring energy source.

In step S1, the receiving module 101 receives a service request requested by the user terminal 2. The service request is requested to gather statistics of an energy usage situation of the monitor object corresponding to the energy sensors 4. The energy usage situation of the monitor object includes the energy loss, the energy usage rate, the CO2e exhausted from the monitor object, for example and then step S2 is implemented.

In step S2, the obtaining module 102 obtains energy input quantity and energy output quantity of the monitor object detected by the energy sensor 4 via the network terminal 3 according to the service request, and then step S3 is implemented.

In step S3, the statistical module 103 loads the greenhouse gas conversion coefficient, the GWP coefficient, and the formulas for calculating the usage situation, which are saved in the storage device 20 to gather the statistics of the energy usage situation of the monitor object including the energy loss, the energy usage rate, and the CO2e exhausted from the monitor object according to the energy input quantity and the energy output quantity, and then step S4 is implemented.

In step S4, the transmitting module 104 creates an energy monitor report according to the statistics of the energy usage situation of the monitor object, and transmits the energy monitor report to the user terminal 2 for the user to check and analyze. The transmitting module 104 further saves the energy usage situation into the storage device 20 to provide the user for continuous monitoring, and gather statistics of the energy usage situation of a yearly statistic and a monthly statistic.

Depending on the embodiment, certain of the steps described may be removed, others may be added, and the sequence of the steps may be altered. It is also to be understood that the description and the claims drawn to a method may include some indication in reference to certain steps. However, the indication used is only to be viewed for identifier purposes and not necessarily as a suggestion as to an order for the steps.

The present disclosure is submitted in conformity with patent law. The above disclosure is the preferred embodiment. Any one of ordinary skill in this field can modify and change the embodiment within the spirit of the present disclosure, and all such changes or modifications are deemed included in the scope of the following claims.

What is claimed is:

1. A method for monitoring an energy source using a server, the method comprising:
receiving a service request transmitted by a user terminal electronically connected with the server, wherein the service request is requested to gather statistics of an energy usage situation of a monitor object corresponding to an energy sensor;
obtaining energy input quantity and energy output quantity of the monitor object detected by the energy sensor according to the service request;
gathering the statistics of the usage situation of the energy of the monitor object according to the energy input quantity and the energy output quantity; and
creating an energy monitor report according to the statistics of the energy usage situation of the monitor object, and transmitting the energy monitor report to the user terminal

2. The method of claim 1, further comprising:
obtaining the energy input quantity and the energy output quantity of the monitor object detected by the energy sensor from a network terminal

3. The method of claim 1, wherein the energy usage situation of the monitor object comprises energy loss, an energy usage rate, and carbon dioxide equivalent exhausted from the monitor object.

4. The method of claim 3, wherein the server comprises a storage device that saves a greenhouse gas conversion coefficient, a global warming potential coefficient, and formulas for calculating the usage situation.

5. The method of claim 4, further comprising:
loading the greenhouse gas conversion coefficient, the global warming potential coefficient, and the formula for calculating the usage situation from the storage device to gather the statistics of the energy usage situation of the monitor object.

6. A server for monitoring energy source, the server comprising:
a storage device;
at least one processor; and
one or more modules stored in the storage device and executed by the at least one processor, the one or more modules comprising:
a receiving module configured to receive a service request transmitted by a user terminal electronically connected with the server, wherein the service request is requested to gather statistics of an energy usage situation of a monitor object corresponding to an energy sensor;
an obtaining module configured to obtain energy input quantity and energy output quantity of the monitor object detected by the energy sensor according to the service request;
a statistical module configured to gather the statistics of the energy usage situation of the monitor object according to the energy input quantity and the energy output quantity; and
a transmitting module configured to create an energy monitor report according to the statistics of the energy usage situation of the monitor object, and transmitting the energy monitor report to the user terminal.

7. The server of claim 6, wherein the obtaining module obtains the energy input quantity and the energy output quantity of the monitor object detected by the energy sensor from a network terminal

8. The server of claim 6, wherein the energy usage situation of the monitor object comprises energy loss, an energy usage rate, and carbon dioxide equivalent exhausted from the monitor object.

9. The server of claim 8, wherein the server comprises a storage device that saves a greenhouse gas conversion coefficient, a global warming potential coefficient, and formulas for calculating usage situation.

10. The server of claim 9, wherein the statistical module loads the greenhouse gas conversion coefficient, the global warming potential coefficient, and the formulas from the storage device to gather the statistics of the energy usage situation of the monitor object.

11. A non-transitory computer-readable storage medium having stored thereon instructions that, when executed by at least one processor of a server, cause the server to perform a method for monitoring energy source, the method comprising:
receiving a service request transmitted by a user terminal electronically connected with the server, wherein the service request is requested to gather statistics of an energy usage situation of a monitor object corresponding to an energy sensor;
obtaining energy input quantity and energy output quantity of the monitor object detected by the energy sensor according to the service request;
gathering the statistics of the energy usage situation of the monitor object according to the energy input quantity and the energy output quantity;
creating an energy monitor report according to the statistics of the energy usage situation of the monitor object; and
transmitting the energy monitor report to the user terminal.

12. The storage medium of claim 11, further comprising:
obtaining the energy input quantity and the energy output quantity of the monitor object detected by the energy sensor from a network terminal

13. The storage medium of claim 11, wherein the energy usage situation of the monitor object comprises energy loss, an energy usage rate, and carbon dioxide equivalent exhausted from the monitor object.

14. The storage medium of claim 13, wherein the server comprises a storage device that saves a greenhouse gas conversion coefficient, a global warming potential coefficient, and formulas for calculating the usage situation.

15. The storage medium of claim 14, further comprising:
loading the greenhouse gas conversion coefficient, the global warming potential coefficient, and the formula for calculating the energy from the storage device to gather the statistics of the energy usage situation of the monitor object.
